(19) United States
(12) Patent Application Publication
(10) Pub. No.: US 2005/0260330 A1
(43) Pub. Date: Nov. 24, 2005

(54) Espresso-based, edible composition and method to form same

(76) Inventor: Tom Larimer, Wilcox, AZ (US)

Correspondence Address: Dale F. Regelman;Law Office of Dale F. Regelman, P.C., 4231 S. Fremont Avenue4, Tucson, AZ, 85714, US

(21) Appl. No.: 11/135,104

(22) Filed: May 23, 2005

Related U.S. Application Data
(60) Provisional application No. 60/573,469, filed on May 21, 2004.

(51) Int. Cl. A23G 3/00

(52) U.S. Cl. 426/660

(57) ABSTRACT

Applicant's invention comprises an edible composition, comprising espresso and milk, where that composition has a room temperature viscosity of at least 50,000 centipoises.

### CROSS REFERENCE TO RELATED APPLICATIONS

This application claims priority from a U.S. Provisional Application having Ser. No. 60/573,469, filed May 21, 2004.

### FIELD OF THE INVENTION

Applicant's invention relates to an espresso-based food product.

### BACKGROUND OF THE INVENTION

Espresso comprises an extract prepared from coffee through which heated water is forced at about 10 atmospheres of pressure. Espresso is generally consumed while hot. Alternatively, some beverages comprise espresso cooled to room temperature or below.

In contrast to prior art espresso-based beverages, Applicant's espresso-based, edible composition is a solid at room temperature.

### SUMMARY OF THE INVENTION

Applicant's invention comprises an edible composition, comprising espresso and milk, where that composition has a room temperature viscosity of at least 50,000 centipoises.

### BRIEF DESCRIPTION OF THE DRAWINGS

The invention will be better understood from a reading of the following detailed description taken in conjunction with the drawings in which like reference designators are used to designate like elements, and in which:

FIG. 1 is a flow chart showing the steps of Applicant's method to prepare his espresso-based composition.

### DETAILED DESCRIPTION OF THE PREFERRED EMBODIMENTS

This invention is described in preferred embodiments in the following description with reference to the Figures, in which like numbers represent the same or similar elements.

Applicant's invention comprises an espresso-based, edible product that has a room temperature viscosity of 50,000 centipoises (cps) or more, where that solid food product comprises about fourteen percent (14%) by weight or more espresso. In certain embodiments, Applicant's food product comprises about twenty percent (20%) by weight or more espresso By “solid at room temperature,” Applicant means a material that has a fixed shape and a fixed volume at about 21° C. to about 23° C.

In certain embodiments, Applicant's food product is formed from, among other ingredients, milk and espresso. In certain embodiments, the milk and espresso comprise more than about fifty weight percent of the ingredients. In certain embodiments, the milk and espresso comprise more than about sixty weight percent of the ingredients.

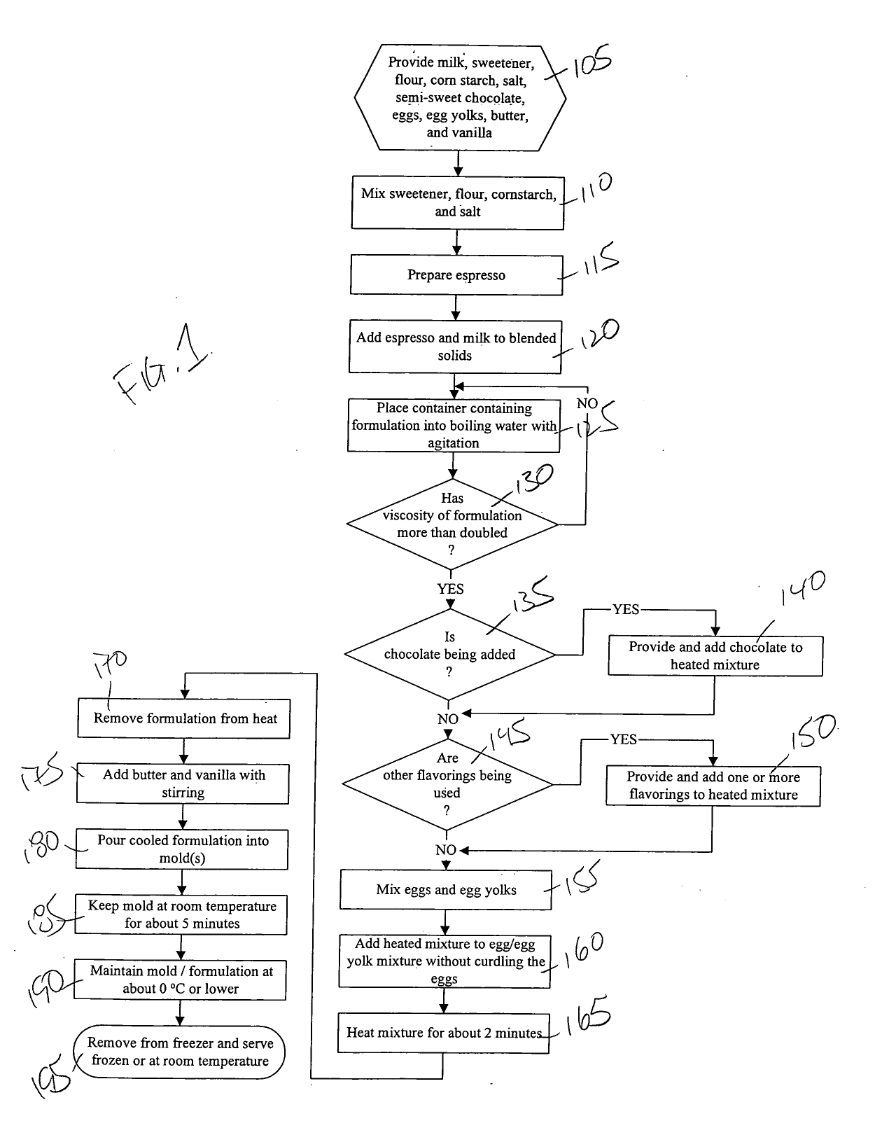

FIG. 1 is a flow chart summarizing the steps of Applicant's method to form his food product. Referring now to FIG. 1, in step 105 the method provides milk, one or more sweeteners, flour, corn starch, salt, semi-sweet chocolate, eggs, egg yolks, butter, and vanilla. By “milk,” Applicant means whole milk, milk comprising about 2% fat, milk comprising about 1% fat, skim milk, and the like. In addition, the “milk” component may be formed using powdered milk and water.

By “sweetener,” Applicant means a naturally-occurring material, such as for example one or more monosaccharides such as for example fructose and the like, and/or one or more disaccharides such as sucrose and the like, and/or one or more non-naturally-occurring materials, such as for example products sold in commerce under the tradenames Splenda and/or Equal, and the like.

In step 110, Applicant's method forms a first mixture comprising solid materials. In certain embodiments, these four solid ingredients include one or more sweeteners, flour, corn starch, and salt. In certain embodiments, the first mixture of step 110 comprises about 25 weight percent of Applicant's food product. In certain embodiments, the first mixture of step 110 comprises about 33 weight percent of Applicant's food product. In certain embodiments, the first mixture of step 110 is prepared in a metal vessel.

In step 115, Applicant's method prepares espresso. By “espresso,” Applicant means about 47-62.5 mL, i.e. 1.5-2.0 ounces, of an extract prepared from about 14 to about 17 grams of coffee through which purified water having a temperature of about 88° C. to about 95° C. has been forced at about 9-10 atmospheres of pressure for a brew time of about 22 to about 28 seconds.

In step 120, Applicant's method formed a second mixture comprising milk and espresso, and forms a third mixture by adding that second mixture with stirring to the vessel which contains the first mixture formed in step 110. In certain embodiments, step 120 is performed within about 5 minutes of completing step 115.

In step 125, Applicant's method disposes the vessel containing the third mixture of step 120 into boiling water. The third mixture is stirred as it heats.

In step 130, Applicant's method determines if the viscosity of the third mixture has about doubled. If Applicant's method determines that the viscosity of the third mixture has not about doubled, then the method continues to heat the third mixture with stirring. Alternatively, if the viscosity of the third mixture has doubled, then Applicant's method transitions from step 130 to step 135 wherein the method determines if Applicant's formulation will include chocolate. If the formulation will include chocolate, then the method transitions from step 135 to step 140 wherein the method forms an enhanced third mixture by adding chocolate to the third mixture of step 120. By “chocolate,” Applicant means milk chocolate, white chocolate, semi-sweet chocolate, mixtures thereof, and the like. Applicant's method transitions from step 140 to step 145.

If Applicant's formulation will not include chocolate, then the method transitions from step 135 to step 145 wherein the method determines if Applicant's food product will include one or more additional flavorings. If Applicant's food product will include one or more additional flavorings, the Applicant's method transitions from step 145 to step 150 wherein the method provides those one or more flavorings, and then forms a second enhanced third mixture by adding those one or more flavorings to the third mixture of step 120 or the enhanced third mixture of step 140. Applicant's method transitions from step 150 to step 155.

If Applicant's food product will not include one or more additional flavorings, then Applicant's method transitions from step 145 to step 155, wherein the method combines the eggs and egg yolks provided in step 105. The egg/egg yolk mixture of step 155 can be formed using conventional equipment and methods, such as for example a blender, a food processor, or using manual stirring.

In step 160, a portion of the heated third mixture of step 125, or the heated enhanced third mixture of step 140, or the second enhanced third mixture of step 150, is slowly added to the egg/egg yolk mixture of step 155 until that egg/egg yolk mixture has been heated to about the same temperature as the heated third mixture of step 125, or the heated enhanced third mixture of step 140, or the second enhanced third mixture of step 150, respectively. Thereafter, Applicant's method forms a fourth mixture by adding that heated egg/egg yolk mixture slowly to the remainder of the heated third mixture of step 125, or the heated enhanced third mixture of step 140, or the second enhanced third mixture of step 150.

In step 165, the fourth mixture of step 160 is heated for about another two minutes. In step 170, the vessel containing the heated fourth mixture is removed from the boiling water. In step 175, Applicant's method forms a fifth mixture by adding butter and vanilla to the still warm fourth mixture. Further in step 175, the fourth mixture is allowed to cool to room temperature.

In step 180, Applicant's method disposes the fifth mixture into one or more molds. By “mold,” Applicant means an enclosure having a floor portion in combination with a plurality of walls and an open top portion. In certain embodiments, the mold defines an enclosed space having a cylindrical shape. In certain embodiments, the mold defines an enclosed space having an essentially rectangular cross-section. In certain embodiments, the mold defines an enclosed space having an irregular shape.

In certain embodiments, step 180 further includes placing a planar member partially into the mold, where that planar member subsequently serves as a handle for Applicant's food product. In certain embodiments, the planar member comprises wood. In certain embodiments, the planar member comprises plastic.

In step 185, Applicant's method maintains the filled mold(s) at room temperature for about 5 minutes. In step 190, Applicant's method freezes the filled mold(s). By “freezing,” Applicant mean maintaining that mold(s) at a temperature at or below 0° C. for about 30 minutes or longer.

In step 195, Applicant's method removes Applicant's food product from the freezer. Applicant's food product can be served in the frozen state, or alternatively that food product can be allowed to warm to room temperature. Even when maintained at room temperature for up to four hours or longer, Applicant's food product maintains a room temperature viscosity of 50,000 cps or greater.

The following examples are merely illustrative of the present invention and should not be considered limiting of the scope of the invention in any way. These examples and equivalents thereof will become more apparent to those skilled in the art in light of the present disclosure.

### EXAMPLE I

The ingredients recited in Table I were combined using the method of FIG. 1 to form a first embodiment of Applicant's food product.

TABLE I

| COMPONENT | AMOUNT | |
|---|---|---|
| ESPRESSO | 93.75 | mL |
| Milk | 312.5 | mL |
| Sugar | 113.2 | Grams |
| Flour | 28.34 | Grams |
| Corn Starch | 28.3 | Grams |
| Salt | 0.593 | Grams |
| Semi Sweet Chocolate | 28.47 | Grams |
| Eggs | 1 | |
| Egg Yolks | 1 | |
| Butter | 7.1 | Grams |
| Vanilla | 7.1 | Grams |

### EXAMPLE II

The ingredients recited in Table 2 were combined using the method of FIG. 1 to form a second embodiment of Applicant's food product.

TABLE 2

| COMPONENT | AMOUNT | |
|---|---|---|
| ESPRESSO | 281.25 | mL |
| Milk | 437.5 | mL |
| Sugar | 226.4 | Grams |
| Flour | 113.2 | Grams |
| Corn Starch | 113.2 | Grams |
| Salt | 2.37 | Grams |
| Semi Sweet Chocolate | 57.0 | Grams |
| Eggs | 3 | |
| Egg Yolks | 2 | |
| Butter | 28.5 | Grams |
| Vanilla | 21.3 | Grams |

While the preferred embodiments of the present invention have been illustrated in detail, it should be apparent that modifications and adaptations to those embodiments may occur to one skilled in the art without departing from the scope of the present invention as set forth in the following claims.

1. An edible composition, comprising:
espresso;
milk;
wherein said food product has a room temperature viscosity of at least 50,000 centipoises.

2. The composition of claim 1, where said espresso comprises more than fourteen weight percent of said composition.

3. The composition of claim 2, wherein said espresso comprises about twenty weight percent of said composition.

4. The composition of claim 2, wherein said milk and espresso comprise more than about fifty weight percent of said composition.

5. The composition of claim 4, wherein said milk and espresso comprise about sixty weight percent of said composition.

6. The composition of claim 1, further comprising:
a sweetener;
flour; and
cornstarch.

7. The composition of claim 6, further comprising chocolate.

8. The composition of claim 6, further comprising:
one or more eggs;
one or more egg yolks.

9. The composition of claim 8, further comprising one or more flavorings.

10. A method of prepare an espresso-based composition having a room temperature viscosity of 50,000 centipoises or more, comprising the steps of:
providing a milk, sweetener, flour, cornstarch, and salt;
forming in a first container a first mixture comprising said sweetener, said flour, said cornstarch, and salt;
preparing espresso;
adding said espresso and said milk to said first container to form a second mixture having a first viscosity;
placing said first container in boiling water until said second mixture comprises a second viscosity, wherein said second viscosity is two times said first viscosity.

11. The method of claim 10, wherein said providing step further comprises:
providing 113.2 grams of sugar;
providing 28.3 grams of flour;
providing 28.3 grams of cornstarch;
providing 0.59 grams of salt;
and wherein said adding step further comprises:
adding 93.75 mL of espresso;
adding 312.5 mL of milk.

12. The method of claim 10, wherein said providing step further comprises:
providing 226.4 grams of sugar;
providing 113.2 grams of flour;
providing 113.2 grams of cornstarch;
providing 2.37 grams of salt;
and wherein said adding step further comprises:
adding 281.25 mL of espresso;
adding 437.5 mL of milk.

13. The method of claim 10, further comprising the steps of:
providing chocolate; and
adding said chocolate to said second mixture comprising said second viscosity.

14. The method of claim 10, further comprising the steps of:
providing one or more flavorings; and
adding said one or more flavorings to said second mixture comprising said second viscosity.

15. The method of claim 10, further comprising the steps of:
providing one or more eggs and one or more egg yolks;
mixing said eggs and said egg yolks in a second container; and
adding said second mixture comprising said second viscosity to said second container to form a third mixture;
placing said second container in boiling water for two minutes.

16. The method of claim 15, wherein said mixing eggs and egg yolks step further comprises adding on egg and one egg yolk for each 93.75 mL of espresso.

17. The method of claim 15, wherein said mixing eggs and egg yolks step further comprises adding on egg and 0.67 egg yolk for each 93.75 mL of espresso.

18. The method of claim 15, further comprising the steps of:
providing butter and vanilla;
adding said butter and vanilla to said third mixture with stirring.

19. The method of claim 18, further comprising the steps of:
providing a mold;
pouring said third mixture into said mold;
cooling said mold to room temperature;
maintaining said mold at room temperature of five minutes;
maintaining said mold at a temperature of 0° C. or less.

20. The method of claim 19, further comprising the steps of:
removing said espresso-based composition from said mold; and
serving said espresso-based composition at room temperature.
